(19) United States
(12) Patent Application Publication
(10) Pub. No.: US 2003/0031029 A1
(43) Pub. Date: Feb. 13, 2003

(54) Rod integrator and illumination optical system using the same

(75) Inventors: Satoru Kawaai, Saitama-shi (JP); Koji Ohgaki, Saitama-shi (JP)

Correspondence Address: Ronald R. Snider, Snider & Associates, P. O. Box 27613, Washington, DC, 20038-7613, US

(73) Assignee: Fuji Photo Optical Co., Ltd, Saitama-shi (JP)

(21) Appl. No.: 10/197,752

(22) Filed: Jul. 19, 2002

(30) Foreign Application Priority Data
Aug. 10, 2001 (JP) 2001-243198

(51) Int. Cl. G02B 6/00

(52) U.S. Cl. 362/551

(57) ABSTRACT

A rod integrator comprises a solid rod-shaped first member and a hollow second member. The first member guides a luminous flux from a light source incident on one end to the other end while totally reflecting the luminous flux on side faces. The second member guides the luminous flux from the first member incident on one end to the other end while specularly reflecting the luminous flux, and then emits the luminous flux from the other end. The first and second members are combined such that substantially all of the luminous flux emitted from the other end of the first member is made incident on one end of the second member.

### RELATED APPLICATIONS

This application claims the priority of Japanese Patent Application No. 2001-243198 filed on Aug. 10, 2001, which is incorporated herein by reference.

### BACKGROUND OF THE INVENTION

1. Field of the Invention

The present invention relates to a rod integrator which can achieve a uniform luminous flux density within a plane perpendicular to an optical axis for a luminous flux from a light source, and an illumination optical system using the same.

2. Description of the Prior Art

Conventionally, video projectors and the like, for example, have often been configured so as to dispose luminous flux density homogenizing means between an illumination light source and an image display device such as a liquid crystal panel in order for the image display device to be illuminated uniformly.

Known as typical luminous flux density homogenizing means are rod integrators. As conventional rod integrators, those disclosed in Japanese Unexamined Patent Publication No. HEI 9-33881 and No. HEI 11-326727, for example, have been known, which are formed as a solid rod prism 100 made of glass as shown in FIG. 6, for example. As shown in FIG. 7, for example, the rod prism 100 guides light beams, incident thereon directly or after being reflected by a reflector 101B from a light source section 101A, toward its light exit end while totally reflecting them a plurality of times on its inner wall faces, thereby yielding a substantially uniform density distribution within a plane orthogonal to the optical axis at the light exit end thereof. Thereafter, illumination light with thus homogenized luminous flux density is turned into a parallel luminous flux by a convex lens 102. As backlight, for example, the resulting parallel luminous flux irradiates an image display device 103 such as a liquid crystal panel, whereby the luminous flux carrying image information is projected onto a screen, which is not depicted, by a projection lens 104.

Meanwhile, such an illumination optical system is configured such that the light exit end face of the rod prism 100 and the device surface of the image display device 103 have an optically conjugate relationship with each other. Therefore, flaws and dust particles on the light exit end face of the rod prism 100 may form images on the device surface of the image display device 103. The images of flaws and dust particles on the device surface may be superposed on the image displayed by the image display device 103, so as to be projected onto the screen as being enlarged by about 50× or greater, for example. Since the flaws and dust particles on the light exit end face of the rod prism 10 are hard to eliminate completely, image qualities have been likely to deteriorate on the screen when such a rod prism 100 is used.

For overcoming such a problem, a hollow prism 105 having mirror inner faces such as the one shown in FIG. 8 has been known. This hollow prism 105 is formed by providing one surface of each of four rectangular glass sheet materials with a reflective coating, and bonding and assembling them so as to form a box having a rectangular cross section such that their reflective coating surfaces are arranged inside. In this hollow prism 105, luminous fluxes incident thereon from the light source side are reflected by the mirror surfaces of the inner walls of the prism a plurality of times so as to be guided to the light exit end. Since the light exit end has no end face which may cause flaws or dust particles attached thereto, no images of flaws and dust particles will be formed on the device surface of an image display device having a conjugate relationship with the light exit end position.

However, unlike the total reflection by the side faces of the rod prism 100 mentioned above, the hollow prism 105 depends on the reflection by the inner wall faces turned into mirror surfaces by the reflective coating. Since the reflective coating on such an inner wall face is hard to attain a reflectance of 100%, the quantity of light reaching the light exit end face may greatly decrease if the reflection is repeated on the inner wall faces by a plurality of times.

### SUMMARY OF THE INVENTION

In view of such circumstances, it is an object of the present invention to provide a rod integrator which can prevent flaws and dust particles on the light exit end face of a prism from forming images on the device surface of an image display device and keep the quantity of light from decaying while passing therethrough, and an illumination optical system using the same.

The present invention provides a rod integrator for receiving a luminous flux from a light source, homogenizing a density of the luminous flux, and then emitting thus homogenized luminous flux, the rod integrator comprising:

a solid rod-shaped first member, positioned on the luminous flux entrance side, for guiding the luminous flux from the light source incident on one end to the other end while totally reflecting the luminous flux on a side face thereof; and

a hollow second member, positioned on the luminous flux exit side, for guiding the luminous flux from the first member incident on one end to the other end while specularly reflecting the luminous flux and then emitting the luminous flux from the other end;

wherein the first and second members are combined such that substantially all of the luminous flux emitted from the other end of the first member is made incident on one end of the second member.

The present invention provides an illumination optical system comprising the rod integrator and an illumination light source for emitting the luminous flux incident on the rod integrator.

Preferably, in this case, the rod integrator is positioned and secured by a holding mechanism, whereas the holding mechanism comprises a substrate and a pressing member having an elasticity.

Preferably, the rod integrator is in contact with the pressing member by a plurality of protrusions provided with the pressing member.

Preferably, each of the first and second members has a substantially rectangular cross section, whereas both of them are shaped in conformity to an image display device irradiated with the luminous flux emitted from the second member.

Preferably, the second member has a total length shorter than that of the first member.

### BRIEF DESCRIPTION OF THE DRAWINGS

FIG. 1 is a perspective view showing the rod integrator in accordance with an embodiment of the present invention;

FIG. 2 is a view showing operations of the rod integrator shown in FIG. 1;

FIG. 3 is a perspective view showing a rod holding mechanism for holding the rod integrator in accordance with the above-mentioned embodiment of the present invention;

FIGS. 4A and 4B are respective perspective views showing a pressing plate and a pressing member which are constituent members of the rod holding mechanism shown in FIG. 3;

FIGS. 5A to 5C are schematic views showing respective rod integrators whose modes of prism combination are different from that of the rod integrator shown in FIG. 1;

FIG. 6 is a perspective view showing a rod integrator constituted by a rod prism alone;

FIG. 7 is a schematic view showing an example of illumination optical system using a rod prism; and

FIG. 8 is a schematic view showing an example of hollow prism.

### DESCRIPTION OF THE PREFERRED EMBODIMENTS

In the following, rod integrators and illumination optical systems in accordance with embodiments of the present invention will be explained with reference to the drawings.

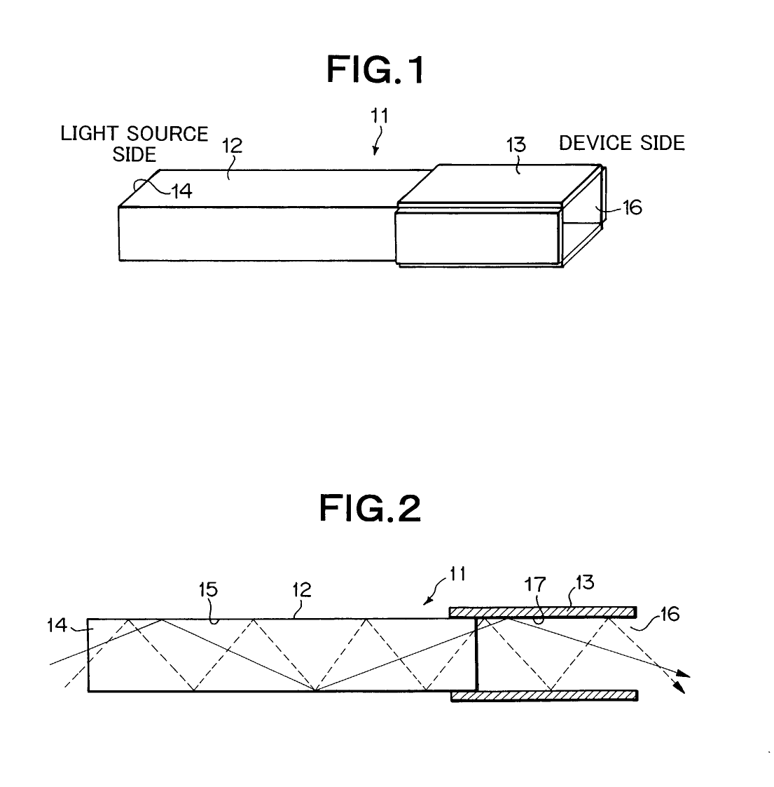

FIG. 1 is a schematic perspective view showing the rod integrator in accordance with an embodiment. This rod integrator 11 is constituted by a combination of a solid rod prism 12 made of glass and a hollow prism 13 having inner faces provided with a reflective coating. Namely, the rod prism 12 is made of a rod-shaped glass rod having a rectangular cross section, whereas the hollow prism 13 is formed by four glass sheets each having one surface provided with the reflective coating which are bonded so as to form a box having a rectangular cross section such that the reflective coating surfaces are arranged inside, one end part of the rod prism 12 being slightly inserted into the hollow prism 13.

For example, this rod integrator 11 is disposed in place of the rod prism 100 in the above-mentioned illumination optical system of FIG. 7, such that the rod prism 12 and the hollow prism 13 are positioned on the light source side and image display device side, respectively. Here, the hollow prism 13 has a length shorter than that of the rod prism 12.

In thus arranged rod integrator 11, as shown in FIG. 2, a luminous flux outputted from the light source 101 is incident on the light entrance end 14 of the rod prism 12 disposed on the light source side. Since this luminous flux is incident on the light entrance end 14 of the rod prism 12 at various angles, its angles of incidence and reflection on inner wall faces 15 of the rod prism 12 vary (though the angle of incidence is such that total reflection occurs at the interface between glass and air). The luminous flux emitted from the rod prism 12 is incident on the hollow prism 13, and is reflected by reflective faces 17 of the inner walls of the hollow prism 13 as in the reflection on the side faces of the rod prism 12, so as to be emitted from the light exit end 16 of the hollow prism 13. Since the mode of reflection varies on the inner wall faces of the rod integrator 11 as in the above-mentioned rod prism 100 and the like, the luminous flux density is homogenized in a cross section perpendicular to the optical axis when the luminous flux is emitted from the light exit end 16.

As a result of such a configuration, since the light exit end 16 is hollow in the rod integrator 11 in accordance with this embodiment, there is no fear of flaws and dust particles forming images on the device surface of the image display device 103 having a conjugate positional relationship with the light exit end 16, unlike the prior art. Also, since the length of the rod prism 12 attaining a luminous flux reflection efficiency of nearly 100% on the side wall face 15 occupies a large proportion of the whole length of the rod integrator 11, the decay of light quantity can be kept lower than that in the prior art using the hollow prism 13 alone.

Though the length of the hollow prism 13 is preferably as short as possible, it is necessary to secure such a length that influences of flaws, dust particles, and the like on the light exit end face of the rod prism 12 do not extend over the device surface of the image display device 103.

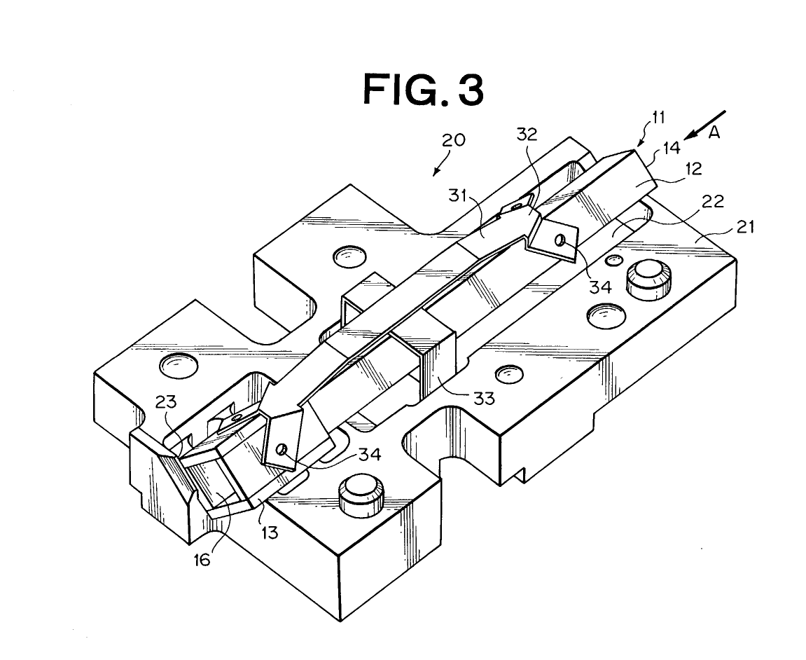

FIG. 3 is a schematic perspective view showing a rod holding mechanism 20 for holding the rod integrator 11 at a predetermined position of an optical system.

This rod holding mechanism 20 comprises a plate member 21 for positioning the rod integrator 11 while in a state where the rod integrator 11 is mounted thereon, and a pressing member 31 for pressing thus positioned rod integrator 11 from thereabove so as to secure it at this position in the vertical direction.

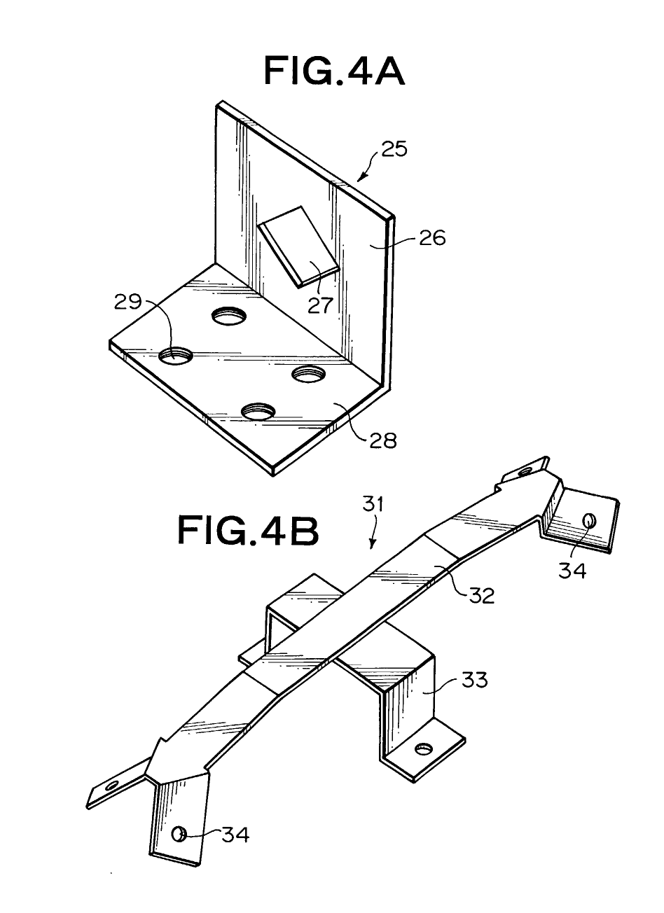

The plate member 21 has a groove 22 extending longitudinally at the center part thereof, and is configured such that, while one longitudinal edge of the rod integrator 11 is arranged at the bottom, two side faces meeting at this edge fit into the groove 22. Also, while in the state placed in the groove 22, the rod integrator 11 is restrained from moving longitudinally. Namely, a part of the wall face of the light exit end 16 of the hollow prism 13, which is one end part of the rod integrator 11, abuts against an abutment 23 raised from the groove 22. In this state, the light entrance end face 14 of the rod prism 12 is urged toward the other end by a pressing plate 25 (see FIG. 4A) attached to the plate member 21.

As shown in FIG. 4A, the pressing plate 25 has an L-shaped cross section. In its raised wall part 26, a rectangular opening 27 smaller than the light entrance end face 14 of the rod prism 12 is formed at substantially the center part thereof. Its bottom wall part 28, on the other hand, is formed with a plurality of screw holes 29 for fastening the pressing plate 25 to the plate member 21 with screws.

When the pressing plate 25 is secured to the plate member 21 by screws, an edge part of the light exit end face 14 of the rod integrator 11 positioned at a predetermined position is supported by an edge part of the opening 27 of the pressing plate 25.

The pressing member 31 comprises a pressing part 32 for pressing the rod integrator 11 from thereabove at four points of the upper face thereof by an elastic force; and a securing part 33, joined to the pressing part 32, having a rectangular U-shaped cross section for securing the pressing part 32 to the bottom face of the groove 22 of the plate member 21 (see FIG. 4B).

The pressing part 32 is configured such that both longitudinal end parts thereof descend from the center part thereof. Each end part is bifurcated, whereas a protrusion 34 projecting from the lower face is formed at the center of each of the bifurcated leading parts.

When the rod integrator 11 is set at a predetermined position so that the securing part 33 of the pressing member 31 is secured to the bottom face of the plate member 21, both end parts of the pressing part 32 of the pressing member 31 urge the rod integrator 11 downward by their own elastic forces. This restrains the rod integrator 11 from moving vertically.

At that time, the rod integrator 11 and the pressing part 32 of the pressing member 31 are in contact with each other by the four protrusions 34, whereby they are in a point-contact state at the four protrusions 34. The point-contact state is attained as such in order to minimize the contact area of members with outer wall faces, which may change the state of reflection when light is reflected by side wall faces of the rod integrator 11. In particular, since the light is totally reflected by the interface between glass and air in the inner wall faces of the rod prism 12, the point contact is preferred as the contact with the pressing member 31.

The rod holding mechanism is disposed so as to place the rod integrator 11 at a predetermined position between the light source 101 and the convex lens 102.

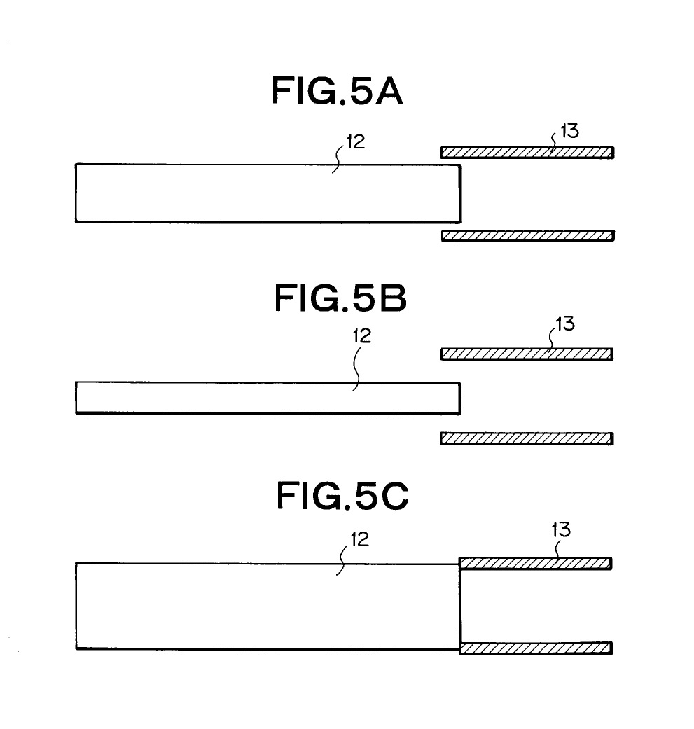

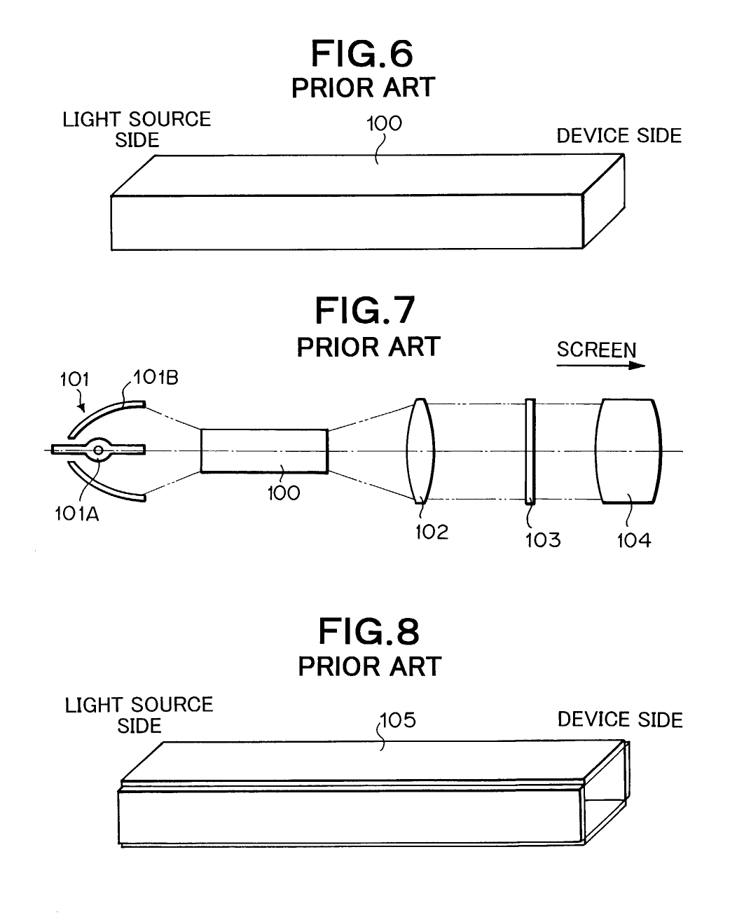

The combination of the rod prism 12 and hollow prism 13 is not limited to the mode shown in FIG. 2. For example, as shown in FIGS. 5A and 5B, the hollow prism 13 may have an inner diameter greater than the outer diameter of the rod prism 12. Also, as shown in FIG. 5C, the rod prism 12 may have an outer diameter greater than the inner diameter of the hollow prism 13. When the light exit end of the rod prism 12 and the light entrance end of the hollow prism 13 are separate from each other, it is preferred that an appropriate mask be disposed at a predetermined position between the two prisms 12, 13 so as to prevent external light from entering the hollow prism 13.

The hollow prism 13 may be formed not only from glass but also from a metal or the like. In the latter case, surfaces to become inner wall faces may be formed beforehand by specular processing.

Though the hollow prism 13 is constituted by four sheet materials in the above-mentioned embodiment, it may also be constructed by two members each having an L-shaped cross section as a matter of course. The original members may have any form as long as inner wall faces can be formed as light reflecting surfaces.

Though the rod prism 12 and hollow prism 13 have a rectangular cross section in conformity to the form of the image display device, they may have other forms such as circular cross-sectional forms, for example, as a matter of course. Operations and effects of the present invention can be attained in the latter case as well.

In the rod integrator and illumination optical system of the present invention, a hollow prism is disposed on the image display device side, so that the light exit end face is hollow, whereby there is no fear of flaws and dust particles forming images on the device surface of the image display device having a conjugate positional relationship with the light exit end, which have been problematic in the prior art. Also, since the length of the rod prism yielding a luminous flux reflection efficiency of nearly 100% at its side wall faces occupies a large proportion of the total length of the rod integrator, the decay of light quantity can be kept lower than that in the prior art using the hollow prism alone.

What is claimed is:

1. A rod integrator for receiving a luminous flux from a light source, homogenizing a density of said luminous flux, and then emitting thus homogenized luminous flux, said rod integrator comprising:
a solid rod-shaped first member, positioned on the luminous flux entrance side, for guiding said luminous flux from said light source incident on one end to the other end while totally reflecting said luminous flux on a side face thereof; and
a hollow second member, positioned on the luminous flux exit side, for guiding said luminous flux from said first member incident on one end to the other end while specularly reflecting said luminous flux and then emitting said luminous flux from the other end;
wherein said first and second members are combined such that substantially all of said luminous flux emitted from the other end of said first member is made incident on said one end of said second member.

2. An illumination optical system comprising the optical system according to claim 1, and an illumination light source for emitting said luminous flux incident on said rod integrator.

3. An illumination optical system according to claim 2, wherein said rod integrator is positioned and secured by a holding mechanism, said holding mechanism comprising a substrate and a pressing member having an elasticity.

4. An illumination optical system according to claim 3, wherein said rod integrator is in contact with said pressing member by a plurality of protrusions provided with said pressing member.

5. A rod integrator according to claim 1, wherein each of said first and second members has a substantially rectangular cross section, both of said first and second members being shaped in conformity to an image display device irradiated with said luminous flux emitted from said second member.

6. A rod integrator according to claim 1, wherein said second member has a total length shorter than that of said first member.
